(19) United States
(12) Patent Application Publication
(10) Pub. No.: US 2021/0312369 A1
(43) Pub. Date: Oct. 7, 2021

(54) AUTOMATED OBJECTIVES TRACKING SYSTEM AND METHOD FOR BUSINESS PERFORMANCE MANAGEMENT AND EMPLOYEE PERFORMANCE

(71) Applicants: Barinder Singh Marhok, Basking Ridge, NJ (US); Tanvir Kaur, Basking Ridge, NJ (US)

(72) Inventors: Barinder Singh Marhok, Basking Ridge, NJ (US); Tanvir Kaur, Basking Ridge, NJ (US)

(21) Appl. No.: 16/842,501

(22) Filed: Apr. 7, 2020

(51) Int. Cl. G06Q 10/06; G06Q 10/10

(52) U.S. Cl. CPC G06Q 10/06395; G06Q 10/1097; G06Q 10/0635; G06Q 10/0637

(57) ABSTRACT

An Internet-based software system for Enterprise Business Performance Enhancement comprises a central computer server system connected to the Internet and adapted to be accessed by one or more authorized personal computers having minimal hardware and software requirements that include a PC with Internet access through a web browser program and/or a mobile handheld device with access to Internet, a mobile browser and/or app. The central computer server system has an operating system, a database management system, high bandwidth connection to the Internet, and an email server system. Four functional software modules of the central computer server system comprise (i) an Enterprise Objectives Distribution module having visual interface and processing components for entering and storing the information on delegation of the organizational objectives from the top to the bottom of an organization; (ii) an Objectives Confidence Assessment module having visual interface and processing components for entering and storing the objective confidence levels of individual employees of the organization throughout a performance year, to derive metrics and document actions taken to enhance confidence levels or achievement of business objectives; (iii) an Objectives Achievement Coaching module having visual interface and processing components for generating, viewing and storing system/peer generated personalized suggestions for employee objectives performance improvement, storing the acceptance from each employee and generating alerts and reminders for the employee of these tasks and activities; and (iv) a Dashboard module showing summary information from each of the other modules.

### BACKGROUND OF THE INVENTION

### 1. Field of the Invention

This invention relates to the field of data processing and analytics; and more particularly to an automated system and method for an objectives allocations and tracking system for business performance management of an organization as well as enhancement of employee performance.

### 2. Description of the Prior Art

Most businesses are structured into functional departments, which are groups of employees such as R&D, Manufacturing, Sales, Marketing, Finance, Accounting, Quality, IT, Administration etc. that report into organization leadership such as CEO, COO. Each of these units is headed by a leader who manages a few senior employees, each of whom manages one or more employees (direct reports) who, in turn, may manage even more employees. This type of organizational arrangement typically leads to a pyramid organization structure.

When managing the business performance of the organization, the management team typically sets the objectives for the organization at the start of a financial year. Most organizations have financial objectives for the year but also have other goals related to customers, products, services, people, financials, production, quality, compliance, legal, and environmental aspects of the business. These targets are passed on to the relevant team members in the next layers of the organization through a process comprising the sequential distribution of targets. For example, a CEO sets the growth target for the company and makes the VP of Sales accountable for achieving that target. The VP of Sales divides this growth target among a few regional Directors. The regional Directors, in turn, distribute the growth target among regional managers who, in turn, allocate the targets to individual salespersons.

Similar department level targets may be distributed into a manufacturing department, for example, to deliver manufacturing outputs in line with the business forecasts for various products with each production manager having responsibility for their respective products or manufacturing locations. Other objectives may include customer satisfaction, employee satisfaction, compliance and quality, which may be applicable to all departments. As this process is followed, typically each employee tends to have 3-10 objectives regarding various areas, such as their direct business responsibilities, responsibilities for the department, people's responsibilities (if manager), quality and compliance, self-development and the like. This method of business management has been a mainstay for performance management during the last few decades. Variations of this model have been deployed in different companies/industries based on the nature of the organization (small, medium, or large business), financial ownership models, products or services, organization structures, the geographical distribution of resources, regulatory reasons, and the like.

While this method has long been followed, the communication of objectives and targets in most organizations is largely carried out using spreadsheet files and emails, and the individual employees enter their own targets into the HR system, if available. One of the problems with this model is that no connection is created between the targets of the manager and the targets of the direct reports. Hence the appropriate distribution of targets in an organization is never ensured, which can lead to problems in business management.

Another problem with the business management process involves the objective tracking process. While the financial objectives are managed very carefully (using worksheets or system reports and meetings with sales staff on a weekly/monthly basis), non-financial objectives are tracked through appraisal feedback sessions conducted 1-2 times a year between a manager and direct reports, and this information is stored in HR systems. This process is highly variable in different organizations. Moreover, the manager is frequently not aware that the direct reports have issues in meeting his objectives. The direct reports' reasons for those issues are not brought to the manager's attention until the appraisal event occurs. Consequently, the manager is unable to proactively assist the direct reports to achieve his objectives. This also increases the chances that information regarding changes in the business environment that would need more urgent interventions are not shared with the right people at the right time. Solutions heretofore proposed and implementations of such systems are complex and have not been adopted at the organization scale for various reasons.

Yet another problem with the business management process is the perception that management feedback on employee performance during the past 6 or 12 months is not fully cognizant of issues the employee encountered. This morphs the manager's role into a reviewer rather than a support for the employee. There exists a varied focus from line managers on helping employees to improve their individual skills and objective achievement. While organizations spend significant efforts on creating better learning experiences for their employees through online and digital tools, the utilization of these tools and training vehicles is relegated to individual employees. For this reason, there exist numerous occasions where employee utilization of tools and training vehicles does not happen.

In view of the aforesaid problems, there presently exists a business management environment wherein objectives are not consistently assigned to individuals, and mid-management is not fully aware of situations where employees require a manager's help to achieve their objectives. Accordingly, at present, individual employees receive sub-optimal support to achieve better business outcomes, despite the best attempts of the management.

To address these challenges, there exists an art felt need for a single platform that can help organizations to ensure that objectives and targets are adequately communicated and distributed. Also needed is a platform that enables mid-managers to support their direct reports better after understanding their day to day challenges. Further needed is a platform wherein employees can learn from the best practices of their managers and peers, in combination with other organizational tools, to achieve better business management practices and outcomes.

### SUMMARY OF THE INVENTION

The present invention provides a method and a software product for business performance management and employee performance enhancement of an organization, comprising (a) an objectives distribution module, for enabling flow down, or delegation, of an objective setting procedure from top to bottom of the organization ensuring alignment of objectives across the organization; (b) an objectives confidence assessment module, which is a flow up system for collecting and analyzing employee objective achievement sentiment on improving business performance from bottom to top of the organization and using the analysis to drive better management support for employees; and (c) an objectives achievement coaching module for helping employees to self-improve themselves. Generally stated, there is provided, a computer system, comprising: (a) an objectives and delegation negotiation module for delegating organizational objectives from top to the bottom of an organization; (b) said objectives and delegation negotiation module being operative to enable a delegating manager at the organization's highest leadership level to store information on new objectives for each annual year, and to digitally transfer the responsibility for executing (delegation) of these new objectives, fully or partially, to said delegating manager's immediate direct reports; (b) said objectives and delegation negotiation module additionally enabling the delegating managers to store information on how frequently he/she wants to see the confidence levels of achieving these objectives and to allocate risks typically associated therewith; (c) said objectives and delegation negotiation module being further operative to store communications between the delegation manager and his/her direct reports for adjustments to the objectives and acceptance thereof with a date and time stamp, thereby creating a delegate-negotiate-accept procedure; (d) upon said acceptance, said delegation and negotiation module being operative to allow each of these direct reports to create and store sub-objectives to their accepted objectives and delegate these objectives to employees who report into them in accordance with said delegate-negotiate-accept procedure; whereby said delegation and negotiation module allows each manager in the organization to delegate all or some of the accepted objectives to their direct reports until those objectives have been delegated to employees who do not have any direct reports.

The computer system of this invention additionally comprises an Objectives Confidence Assessment module for identifying throughout a performance year the objective confidence levels of the organization's employees; The Objectives Confidence Assessment module is operative to allow the employees to enter their confidence levels at specified intervals on achieving their objectives and additionally enter/rate the risks that can potentially affect their confidence levels. Risks levels reported by each direct report are updated to the existing risks for the respective manager. A weighted average of the confidence levels is averaged to derive a personal objectives confidence score for each employee on a given date and tracked over the year to monitor the confidence of each employee concerning the achievement of objectives. The personal objectives confidence score of all direct reports is averaged for each employee-manager and data from said direct reports is aggregated and presented to said employee-manager by said Objectives Confidence Assessment module to enable said employee manager to assess his team's confidence levels and create a common understanding with the direct reports.

The computer system further comprises an Objective Achievement Coaching module operative to improve personal performance levels. This allows the employee to see suggestions derived from best practices stored by other individual employees to create tasks for these and setup repeated reminders with the goal of improving personal performance and convert his personal habits to best practices.

In a first embodiment, the system and method of the invention facilitate the flow down of objectives-setting by providing software that enables the top layers of an organization to create an annual objective/s and flow it down to each of delegating manager's direct reports in a trackable manner. The system and method also ensure that each employee manager's direct reports are able to clarify/accept/decline these objectives. In the event that the direct reports have other team members reporting to them, the process of objective flow down is repeated until substantially all the layers of each functional unit have accepted their objectives. A dashboard for each leader/employee manager is configured to display the percentage of their direct reports that accepted their targets, thereby creating for the leader complete visibility the progress of direct reports for achieving their business performance targets. This system, process, and software represent a significant improvement over available management options.

In a second embodiment, the system and method of the present invention address the manner in which the employees of an organization report on the objectives they accepted during acceptance time intervals and informs the leader/employee-manager concerning the likelihood that they will be able to achieve the targeted objectives. An interface is established through which the team members who do not have any delegates for the said objective are required to provide their confidence levels for achieving their targets and identify the risks and factors that lead to the confidence levels for each of their objectives at pre-determined intervals. This interface makes use of the weighted average confidence score of each employee, herein referred to as the Personal Objective Confidence Score (“POCS”). It also utilizes the weighted average confidence score of the direct reports of a manager, herein referred to as the Team Objective Confidence Score (“TOCS”). Generation of a POCS enables an individual employee to have self-realization concerning the need for improved performance, while generation of a TOCS provides employees with management responsibilities with an increased awareness concerning the sentiment in their direct reports and the actions which are likely to enhance their business performance. Implementation of objective-setting/reporting through a POCS/TOCS interface and tracking it through the performance year will drive strategic and operational decisions from everyone in the team, thereby leading to improved business performance.

A third embodiment of the present invention comprises a software module that enables the employees to understand (i) what they can do to improve the achievement levels of their objectives, and (ii) an appropriate approach for reaching sustainable behavior changes that will sharpen individual skills. This module comprises sets of suggestions and reminder/alert features that help employees understand what steps they can take to improve their professional lives and potentially make them a habit. The enablement features in this software module drive user satisfaction and increase chances for adoption of the POCS/TOCS interface by each individual employee. Collectively the aforementioned three embodiments operate to (i) improve processes used by organizations set to achieve their business performance objectives; (ii) create a recurring way to capture employee sentiment on achieving objectives; and (iii) guide management to better decisions while creating better ways for employees to manage their careers.

### BRIEF DESCRIPTION OF THE DRAWINGS

The invention will be more fully understood and further advantages will become apparent when reference is made to the following detailed description of the preferred embodiments of the invention and the accompanying drawing, in which:

FIG. 1 is a block diagram depicting the objectives, approach to achieve them and solutions components of a business performance enhancement system of the invention;

FIG. 2 is a block diagram illustrating three categories of employees in an organization from the perspective of setting and delegating objectives: L1 employees: who just create and delegate objectives, L2 employees: who accept objectives from their manager but also delegate them to their direct reports, L3 employees: who accept objectives from their manager but have no direct reports;

FIG. 3 schematically illustrates an organizational hierarchy containing various layers of the organization including L1, L2 and L3 employees for which the present invention would be applied;

FIG. 4 is a block diagram that illustrates the physical and logical components of a system wherein data interactions occur;

FIG. 5 is a flow chart illustrating a process for setting objectives and flowing them down the organization;

FIG. 6 is a flow chart illustrating a high-level process for collecting employee confidence levels for achieving objectives and creating confidence scores for higher layers of management;

FIG. 7 is a flow chart illustrating an employee coach system wherein employees utilize contextual and personalized ideas and recommendations to improve their performance;

FIG. 8 illustrates a user interface of the dashboard that the users see when they login to the system software;

FIGS. 9-13 depict interfaces for a delegating manager to manage his direct reports, setup annual objectives and delegate these to his direct reports;

FIGS. 14-16 depict interfaces that users will use for providing confidence levels on their objectives, assign and adjust risk levels and aggregate these to the higher levels;

FIG. 16A is a Table showing a POCS calculation;

FIG. 16 B is a Table showing a TOCS calculation; and

FIGS. 17-18 depict example interfaces for users to see crowd sourced ideas and suggestions for improving individual objectives and converting these to tasks with reminders.

### DETAILED DESCRIPTION OF THE INVENTION

Employees of large or small organizations are generally delegated annual objectives by their managers and are required to provide confidence ratings on their ability to achieve their objective targets along with the reasons for the rating. Weighted average confidence ratings are calculated and made available to the manager to help/guide his direct reports to drive business performance improvements. In addition, based on the confidence levels, employees receive advisory inputs from the system on how to improve their personal objective confidence levels and business performance.

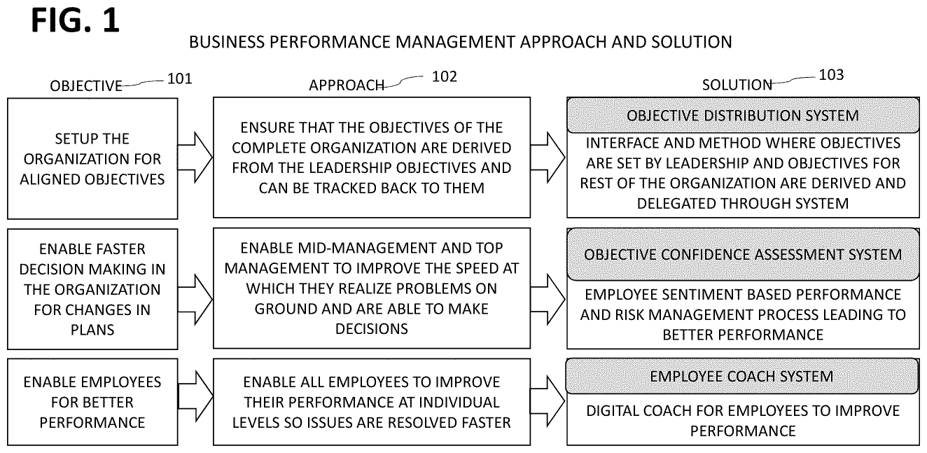

FIG. 1 schematically illustrates the objectives (101), approaches (102), and the solutions (103) through which business performance enhancements can be achieved for an organization. In the model depicted, business performance enhancement goals are achieved through holistic changes across an objectives setup, performance tracking, and individual performance enhancements. The invention comprises a comprehensive system that provides each of these capabilities in an integrated manner.

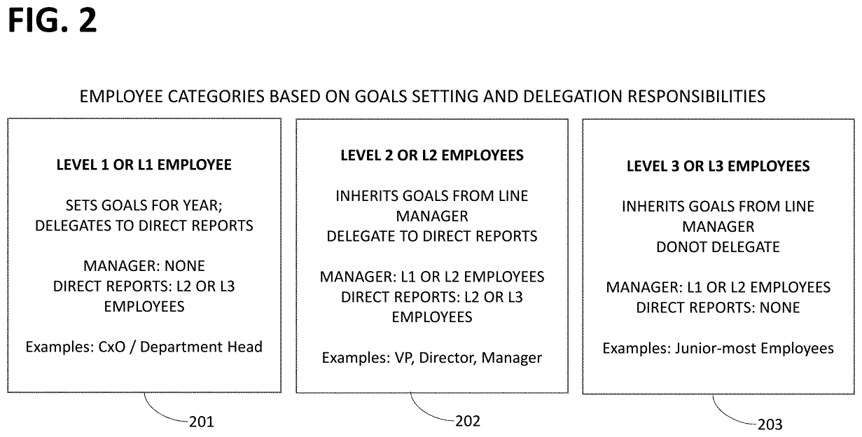

FIG. 2 represents the types of employee categories based on their responsibility to set objectives and delegated objectives. L1 employees (201) are able to set the targets of an organization and delegate these to their direct reports. L2 employees (202) inherit the targets for L1 or other L2 level employees and can delegate the objectives to other L2 or L3 employees. L3 employees (203) can inherit objectives but do not have direct reports and hence are not able to delegate these to anyone.

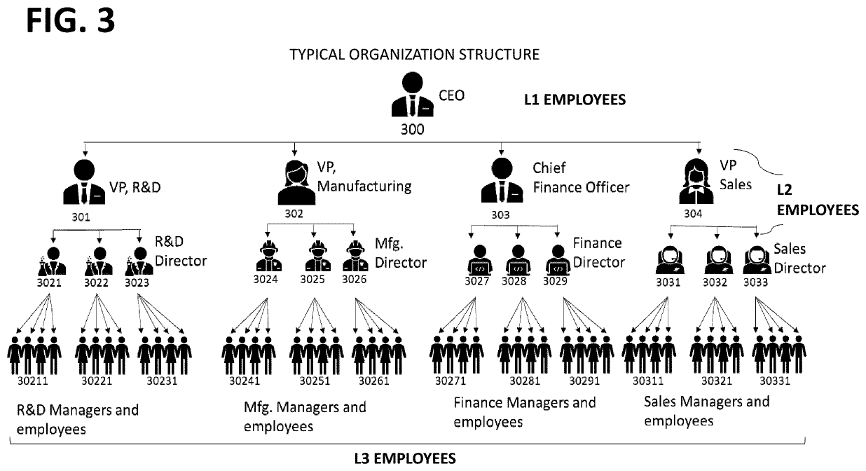

FIG. 3 schematically depicts an organization. Employees in L1 layer comprise the most senior employees of an organization, e.g., CEO, CFO, CIO. For example: A CEO of an organization 300 sets the target revenue of $12Mn by December 31^{st} of the year and delegates the revenue target to VP of Sales” 304. L2 employees comprise the many layers of mid-management who inherit the target from their manager and distribute the target to their direct reports. VP of Sales 304 would inherit the target from CEO 300 and delegate a revenue target of $4 Mn to each of Sales Directors 3031, 3032, 3033, which comprise his direct reports. Each of Sales Directors 3031, 3032, 3033, in turn, delegate to the 4 Sales Managers a revenue target of $1Mn each. VP of Sales 304 and Sales Directors 3031, 3032, 3033 represent L2 employees. Because the Sales Managers do not have any direct reports, they are deemed to be the L3 employees.

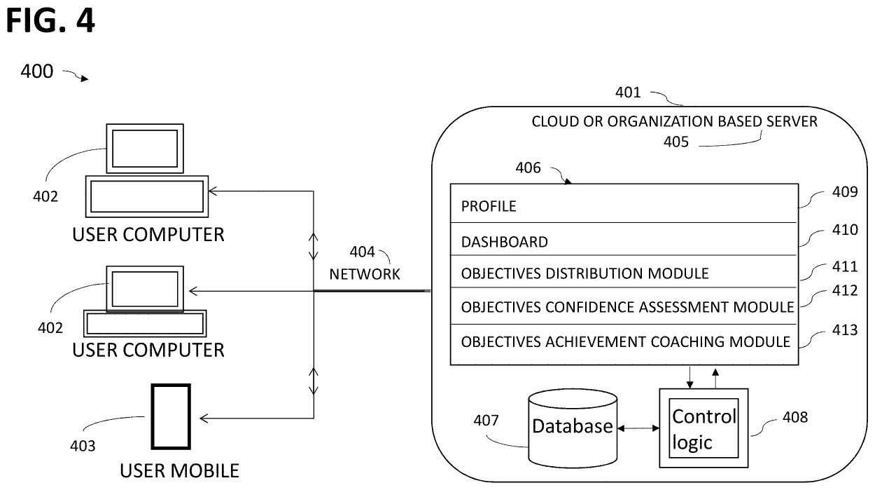

FIG. 4 is a block diagram wherein the computer system 400 represents the complete usage environment of the present invention. The core invention, herein referenced as Enterprise Performance Enhancement System 401, comprises application functional modules 406, a database store 407, and a control logic module 408, which controls the data exchange between database store 407 and application functional modules 406. The application will be hosted on a server 405 in the public/private cloud. The system may also be hosted on an internal server of an organization, should that arrangement be required by the adopting organization. The server 405 provides an operating system that is required to run the application. Users can access the system from computers and laptops 402 and mobile phones 403. The information between the users' laptops/mobile devices and server 405 is communicated through the network 404 using security controls, which selectively allow permitted information to be viewed by each user.

Within the Application functional module component 406, which provides the user interface for viewing and editing data, there are 5 sub-modules 409-413. These 5 sub-modules provide the functionality of the system, as hereinafter described. Profile module 409, wherein each user documents his past experience, performance, and aspirations, has not been detailed herein, as the operative parameters of this module are present in conventional systems. User Dashboard 410 shows the summary information from other modules for the user to obtain his status quickly. The Dashboard 410 module has not been detailed herein, as it is likewise present in conventional systems. Objectives Distribution module 411 allows the L1, L2, L3 employees to set new objectives, delegate them to their direct reports, and accept them when they are assigned new objectives. 4) Objectives Confidence Assessment module 412 allows all employees/users to provide their confidence levels on their objectives on a required frequency basis (weekly/monthly/quarterly) and shows aggregated confidence scores for each layer of the organization. 5) Objectives Achievement Coaching module 413 assists the user with selection of new skills and habits which, when acquired, are likely to achieve better outcomes. New skill selection is based on the user's aspirations and ability to manage the selected skills over time.

The desktops, mobile devices, networks, and other components required for the operation of environment 400 are conventional systems and operate in a conventional way. These components are routinely procured from industrially/commercially available technologies and are well known by those skilled in the art.

### Objectives Distribution Module

The purpose of this module is to create complete traceability between the objectives of the leadership team to the bottom of the organization pyramid. The other key difference between this module with other arts and other systems available in the market is that this puts the onus of documenting the objectives delegation a responsibility of the manager instead of responsibility of the direct report to create his own.

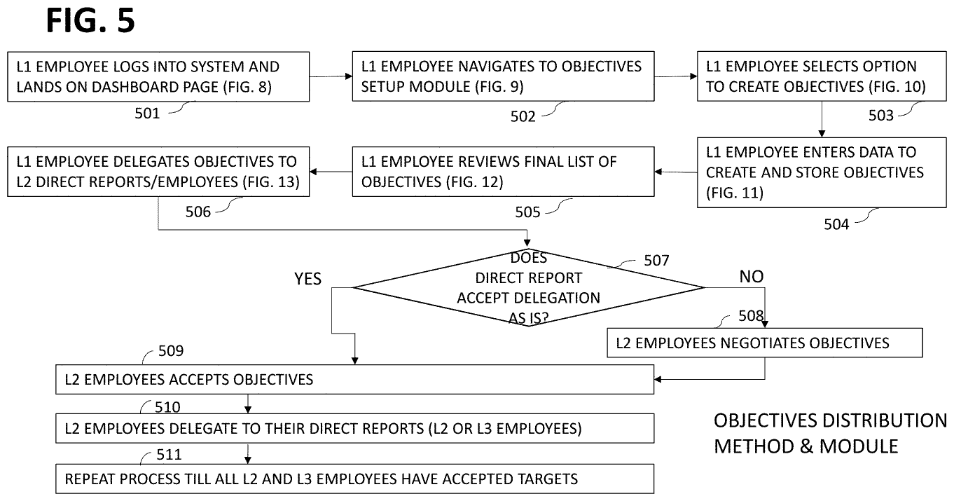

In FIG. 5 there is depicted a flowchart for an embodiment of the Enterprise Performance Management System 401, showing a process wherein, at the start of an annual year, performance objectives are created and accepted across a complete organization. In this embodiment, it is assumed that the employees of the organization have created their profiles and selected their direct reports during the creation of their profiles, or the direct reports were assigned to certain roles through integration/data imports from existing HR systems. It is additionally assumed that the employee has securely logged into the system, and the system has automatically activated certain features based on the profile and hierarchical level of the employee.

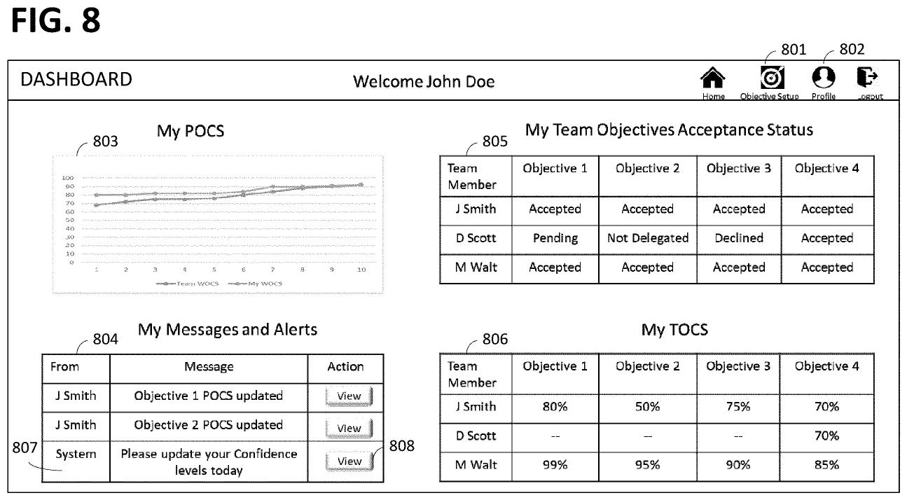

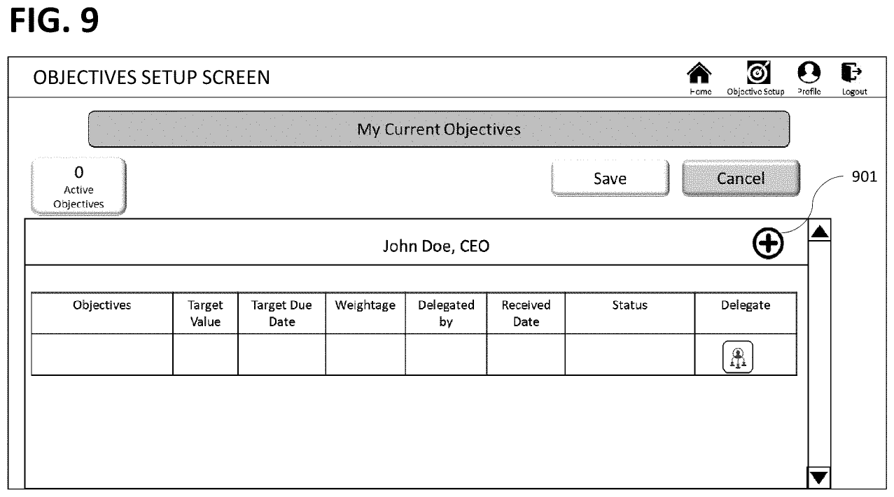

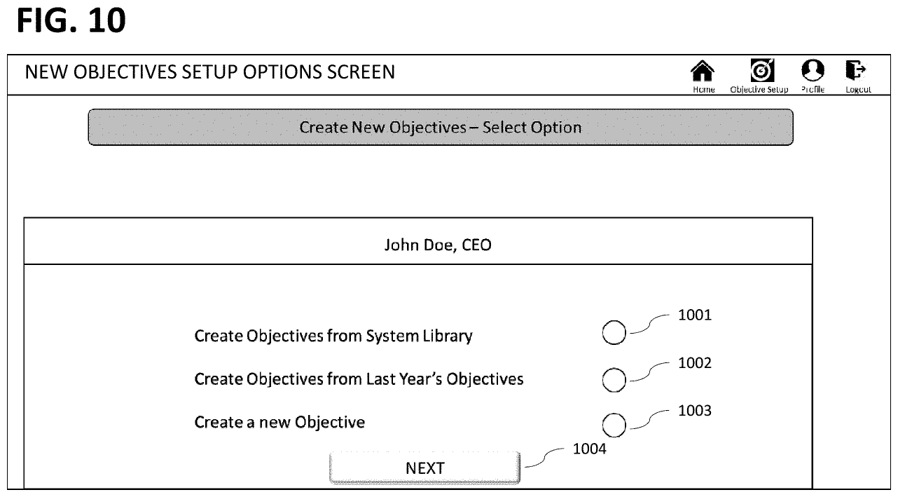

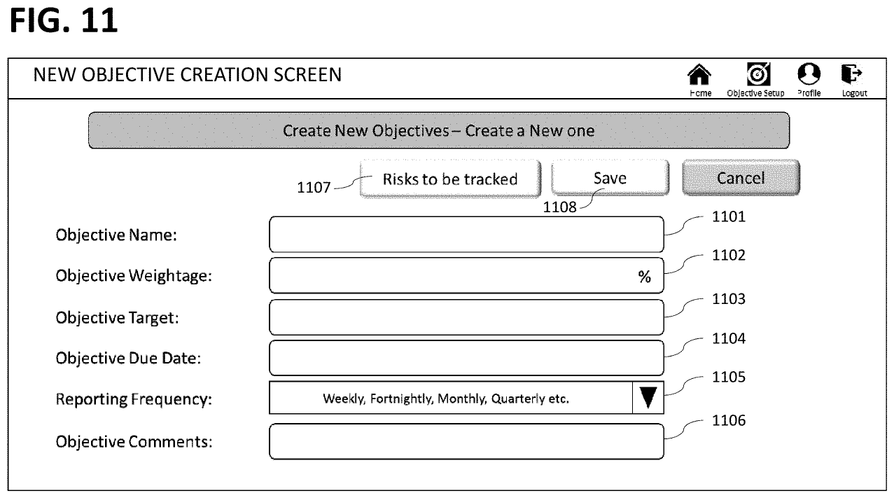

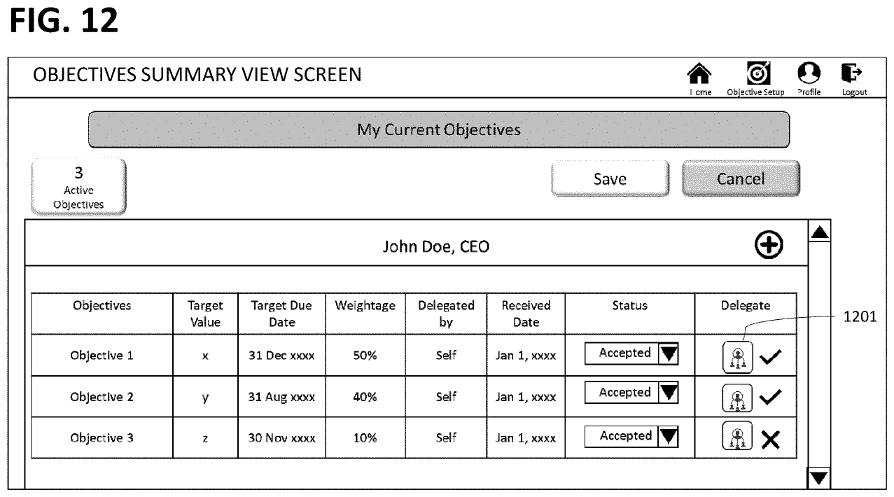

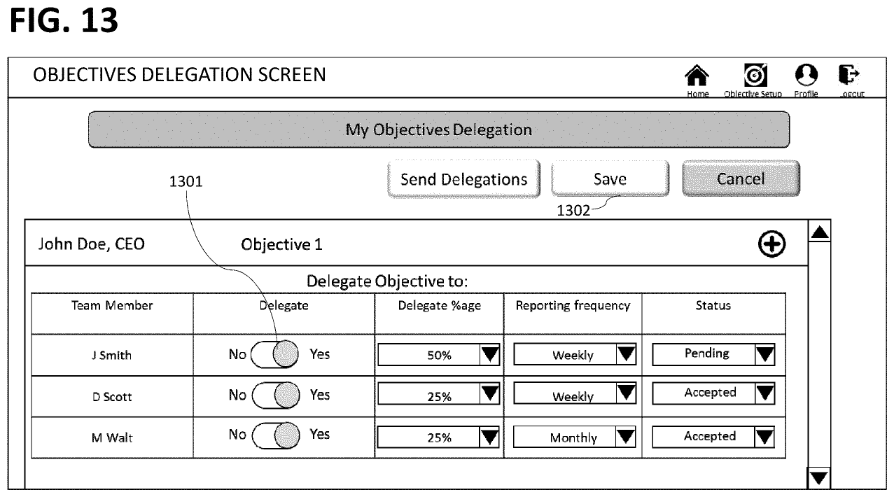

As shown by FIG. 5, the flow starts at block 501, with the Enterprise Performance Enhancement system 401 running on the server. One of the senior/leader employees of the organization (L1 employee) wishes to create his corporate objectives for the financial year. This L1 employee may set the goals for the whole organization (for example: A CEO/COO of the organization) or may set the goals for his department (example xVP of Sales may set the objectives for the global sales teams). The employee, in this case, the L1 employee, logs into the system from mobile app 403 or web application on his computer 402.
Block 501: Employee logs in and lands at the dashboard page, shown in FIG. 8.
Block 502: The employee opens the functional module “Objective Distribution” by clicking the widget 801 in the menu/menu bar of the application and a new graphical user interface (GUI) screen, shown in FIG. 9, is presented.
Block 503: Employee clicks on widget 901 for creating a set of annual objectives. On clicking this widget, the Employee obtains options for creating the new objective: a) create one from scratch b) inherit objectives from previous years c) select one from a library. This is shown in FIG. 10. On clicking on the “NEXT” button, the system navigates to the screen shown in FIG. 11.
Block 504: As shown in FIG. 11, the employee fills the required data fields 1101-1106 on the GUI screen setting objective name, target value, target completion date, and weightage of this objective. The employee clicks on button 1107 and is able to enter data on risks that should be tracked for this objective and presses button 1108 to save the data.
Block 505: Employee repeats the process for as many objectives he wants and sets the target weights in a way that they total up to 100%. The employee is now ready with his own objectives and is now ready to delegate/flow down these to his direct reports.
Block 506: Employee iterates through each of his objectives and for each one, clicks on the Delegate widget 1201, and the Delegation GUI screen opens as shown in FIG. 13. For each of the objectives, the employee can see all his direct reports (L2 users) on this screen. The employee uses the switch buttons 1301 to select whether he will delegate the objective to his direct report or not. If the decision is to delegate, the employee needs to provide more details of delegation, such as Delegation percentage, expected reporting frequency, and other data values. The employee can save the data by pressing the “Save” button (1302) at any time. Once the employee completes this process for all his objectives, he presses the “Send Delegations” button 1303 to send the delegations to his direct reports for that objective. The employee now repeats the delegation process for the next objective till all the objectives have been delegated to the next layer.

Process flow now moves to the Direct reports of the employee above (L2 users), to whom the Employee in the previous steps has delegated the objectives. The employee flow at the login step is the same as mentioned in block 501.
Block 507: On his dashboard, the L2 employees see messages that they have received Delegations from their manager. Each L2 employee reviews the objectives delegated and can choose 3 actions: a) Accept, b) Comment, c) Decline.
Block 508: Employee chooses the action he wants, and based on the choice, he gets to provide additional data such as comments or reasons for declining.
Block 509: Typical manager and direct report negotiations are enabled by the system until all objectives have been accepted by the direct report employees (L2 employees). Now the objectives of the first L2 employees are complete. The system may permit the employee to fine-tune/make changes to the objectives so that they are relevant for their direct reports. Even if fine-tuning/changes to the objectives are made, the system maintains the linkage between the objectives received from the manager and delegated down to their direct reports.
Block 510: L2 employees follow the same steps as in Block 506 to delegate or flow down their objectives to their L2 and L3 direct reports.

This process is continued until all employees throughout the entire organization have accepted their objectives and targets for the year.

### Objectives Confidence Assessment Module

The purpose of this module is to create a metric based on sentiment analysis of the employees during the year as a way to assess the risk in achieving objectives and ensure that the mid-management is helping their teams to achieve the goals in a traceable and trackable manner. This tackles the significant variations in the management styles of various mid-management employees and puts a structured way of ensuring that they are supporting the employees in meeting the objectives. This also ensures that all layers of the organization practice risk management principles for the execution of their daily jobs. This is in contrast to the other existing methods of performance management, which are largely based on carrot and stick approaches of high bonuses and similar rewards of achievement of goals and reduced bonuses on non-achievement.

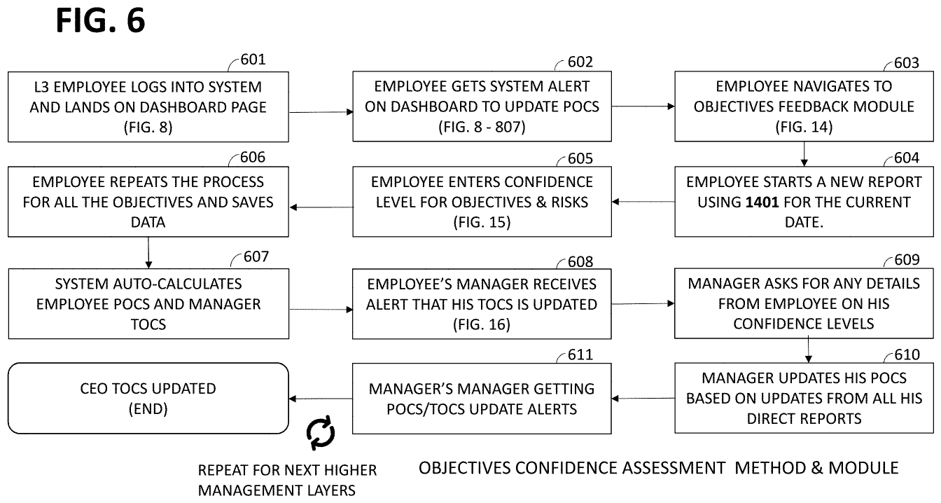

FIG. 6 is a block diagram depicting the workflow followed by employees for the Objective Confidence Assessment Module of the Enterprise Performance Enhancement Module 401. The idea of this process is to create a corporate view of the objectives and how the management can support the team on the ground in a better way so that everyone is more successful in achieving their goals.

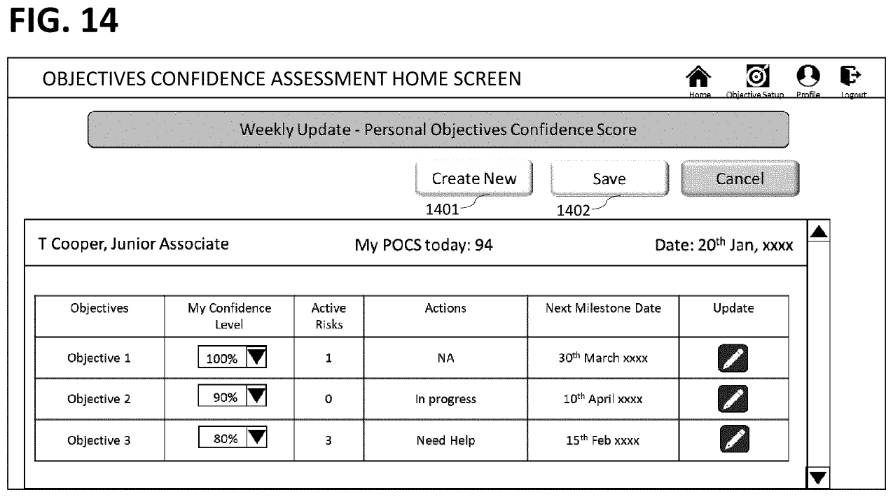

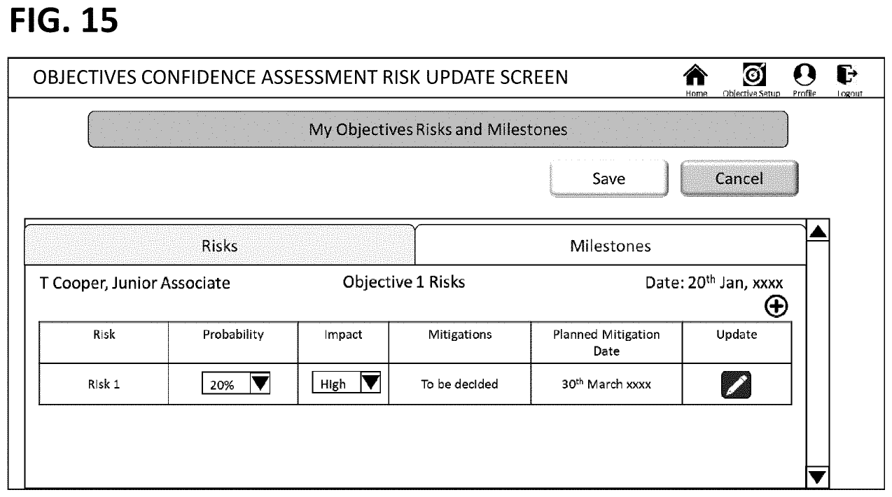

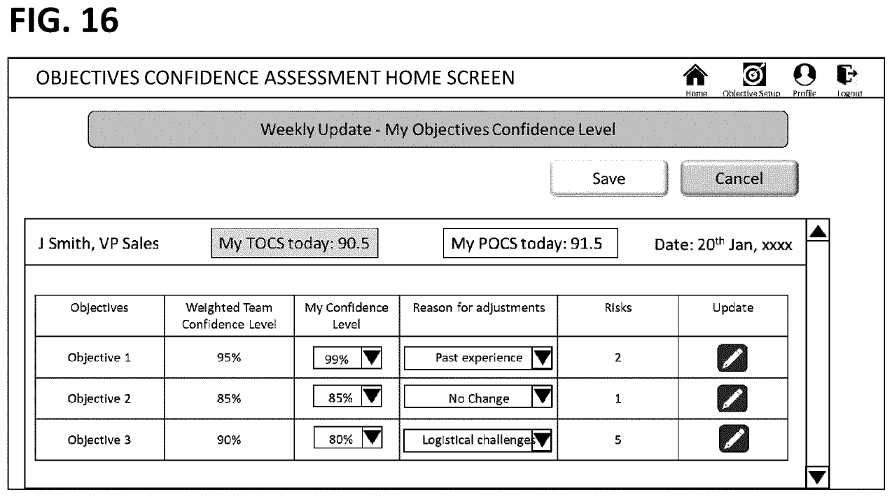

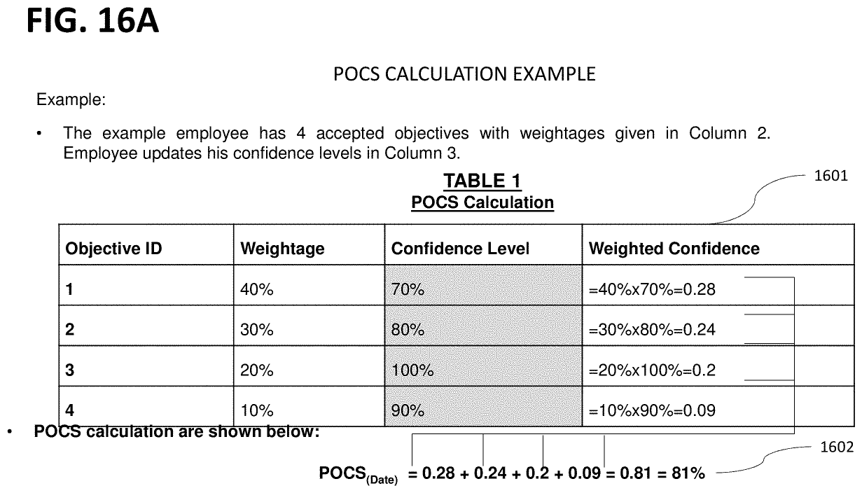

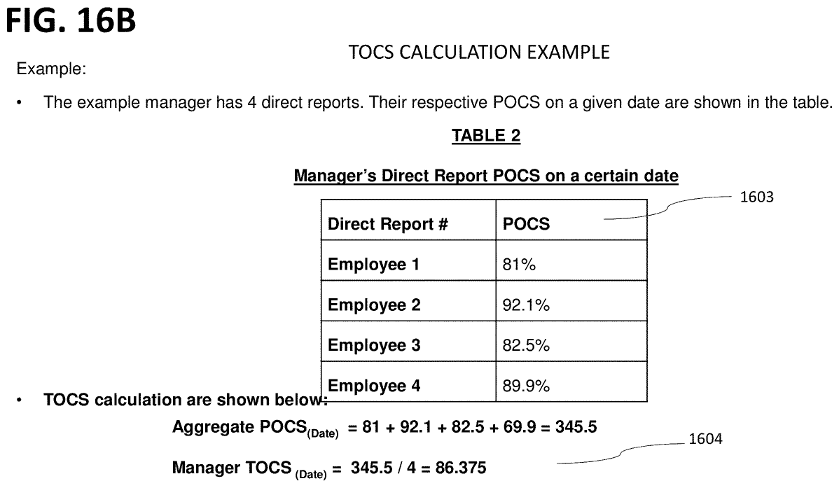

This workflow assumes that the employees have accepted their objectives and targets for the year. As shown in the process for delegation of objectives, all managers have provided their expectations on how frequently they want to obtain feedback/confidence assessments from their direct reports on each of the objectives. This frequency data is now used by the system to create tasks and triggers for employees to provide their confidence assessments on the objectives. The confidence level is a percentage confidence of the employees ranging between 0-100%, for achieving the specific objective within the time period determined by the Objective Target Date. The employee may also be asked to answer other questions besides their confidence levels. Consider, for example, an objective such as the Sales Target, which has been distributed from the CEO to the 12 sales managers across a geographical region through 2 layers of sales management leadership (VP Sales and 3 Sales Directors). Assume further that the CEO wanted feedback on this objective every week. Under these conditions, the 12 sales managers will receive alerts in the application that they need to provide their feedback on every Friday afternoon. The block diagram in FIG. 6 shows the process that will be followed:
Block 601: L3 employees (e.g., Sales Managers) login to the application.
Block 602: Employees see alerts that they need to update their confidence levels (POCS) as shown by 807 in FIG. 8.
Block 603: Employee navigates to the Objective Confidence Assessment module shown in FIG. 14 by clicking the widget 808 on the dashboard page.
Block 604: Here, the employee creates a new entry for the current date using widget 1401, which opens the screen that allows the entry of confidence levels on the objectives.
Block 605: The employee enters and saves the data and may be prompted by the system if he wishes to update the risks/sub-milestones on this objective. If yes, he is able to click the prompt and application navigates to the respective GUI screens to allow for this data entry and saving the data, as shown in FIG. 15.
Block 606: The employee now updates his confidence levels and risks on the remaining objectives due at this time and saves the data by using the widget 1402.
Block 607: As soon as the employee completes all the updates, his POCS auto-calculates with the new confidence levels, as explained hereinafter in the section entitled “POCS Calculation”.
Block 608: As soon as one of the employees updates his POCS, the employee's manager receives an alert message that his direct report has updated his POCS, and his TOCS is auto calculated. The manager can view his refreshed TOCS on his dashboard and Objectives Confidence Assessment Module on logging into the system, as shown in FIG. 16.
Block 609: Manager/Direct report can exchange messages for understanding any reasons for changes and make any further adjustments.
Block 610: The manager now can update his POCS based on the inputs he received from his direct reports and his TOCS.
Block 611: Now, the manager's manager receives the alerts his direct report/s have updated their POCS, and he follows the same process of getting feedback.
This process continues to move upwardly to the highest levels of the organization until the CEO gets the messages that his TOCS is updated. As changes occur on the ground with respect to business-critical objectives, these changes shape the management views concerning course corrections/strategic changes that need to be carried out on an ongoing basis.

### POCS and TOCS Calculations

The formula below shows the calculations for POCS.
Employee POCS(Date)=Σ₁^{y}(Objective Weightage×Confidence Level); where y=Number of objectives for the employee

FIG. 16A shows an example of the POCS calculations for each employee. The example shows the calculations for an employee who has accepted 4 objectives at the start of the year with objective weightages represented in column 2 of the table. The employee has given his confidence levels on each of the objectives on a particular date. Employee POCS is calculated by creating the weighted confidence levels for each of the objectives by multiplication of Weightage and confidence levels and then aggregating the weighted confidence levels of all the 4 objectives in this example.

FIG. 16A shows that the example employee has 86.375% confidence in achieving all his objectives and there exists a need for the employee to (i) create an action plan that addresses the gap on Objective 1 as it has the maximum weightage; or (ii) seek help from his peers/manager on addressing issues not within his control.

As the year progresses, POCS will keep varying, based on the confidence levels, which provide an indicator concerning the ground realities faced by the employee when meeting his objectives. The advantage of POCS over current ways of measuring employee performance is that it is a composite metric for all the objectives of an employee except for only a select few (e.g., financial objectives). It gives an employee a holistic view of his performance and helps him to focus himself on all-round development.

### TOCS

The formula below shows the calculations for TOCS
Manager TOCS_{(Date)}=(Σ₁ⁿ(Direct Report POCS))/n; where n=number of direct reports of the manager

Another representation of the same formula is Manager, TOCS_{(date)}=POCS For Direct Report 1+POCS for Direct Report 2+ . . . POCS for Direct Report n/n, where n=the number of direct reports of the manager

FIG. 16B shows an example of the TOCS calculations for an example manager who has 4 direct reports. In the example, on a certain date, the POCS for respective employees are shown in table 2 of FIG. 16B. Manager's TOCS is calculated by adding the POCS of each of the direct reports and dividing by 4 (as there are 4 direct reports).

The example shows that the manager has a confidence level of 81% of hitting all the objectives he has delegated to his team. However, Direct Report 4 must make a significant effort to meet his objectives and specific focus and attention will be required to support that team member and/or immediately adjust targets for others so that the manager has a higher chance of achieving his own objectives. TOCS as a way of comparing direct reports is better than any other ways practiced in the business world today as it gives an easy way for the manager to identify which employee needs more support and focus his attention to ensure that the direct reports are all able to achieve their targets.

### Objective Achievement Coaching Module

A coach is a person who monitors the baseline performance of a subject (could be an athlete or a corporate professional), identifies improvement areas, and helps the subject to practice the skills needed for improvement till these become a natural part of the subject's way of execution. While corporations cannot invest in human coaches for each of their employees, the responsibility is usually given to their line manager or functional manager to mentor their direct reports. These managers may or may not have the skills, desire, bandwidth to execute these responsibilities leading to mixed experiences for employees in the organization.

A digital coach may fill the void in a very economical manner and would implement these activities with consistency while giving the flexibility to the employee to manage the guidance in a flexible manner in alignment with their workloads, capabilities, personal styles, and aspirations. Even a marginal improvement in the capabilities of the employees of an organization may lead to improvements in business performance and also improve employee satisfaction for the organization. Needless to say, that not all employees would ever become best performers just like with human coaches; not every coached person becomes the best in a field.

The purpose of this module is to offer a digital coach for each employee to help them achieve their corporate objectives and to make the achievement of corporate objectives integral with the employee mindset, as part of a professional style/way of thinking. While similar reminder applications for habit building are present in the industry, these are not oriented towards professional objectives management, nor do they proactively suggest new ideas that are crowd-sourced from the organization. The guidance suggested by the digital coach is highly contextual to the environment/challenges of the organization and also leverage the collective knowledge of an organization. Examples of guidance suggestions may include recommendations like an employee should increase his communications to his manager, or his organization by publishing whitepapers/blogs, etc. (general management resources) or increase the sales calls (for a salesperson) or become more risk-oriented (project managers) etc. and send reminders to encourage him to get it done.

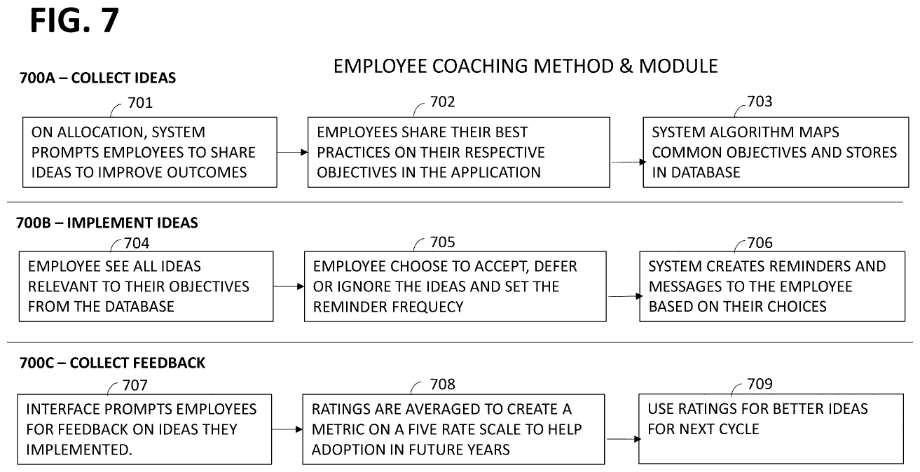

FIG. 7 is a block diagram showing the process flow for the Objective Achievement Coaching module. The process flow therein depicted assumes that the employee has logged into the application either by phone or computer.

The enterprise-level process is depicted in three different sub-processes:

Sub-Process 700A (Source Ideas)—The module enables the system to crowdsource ideas from leaders, managers, and employees on what best practices they want others to follow for improving their performance. The ideas could range from personal traits and best practices, industry best practices, ideas from other industries.
Block 701: In this block, the employees who have accepted their objectives are required to share ideas that they think will improve their attainment of these objectives by their direct reports. They are presented the user interface screens that will help them document these ideas.
Block 702: Employees enter their ideas into the Module. There may be some rewards system for adding values that could be put in place. These ideas are stored in the database.
Block 703: The back-office algorithms/support team may be used to cleanse, curate, and standardize the data, connect the objectives to roles where relevant so that these can be interpreted correctly by other employees.

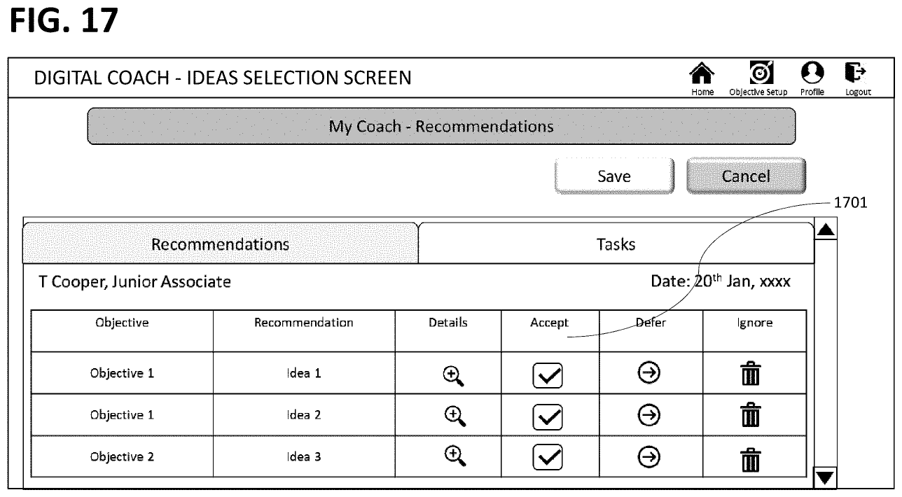

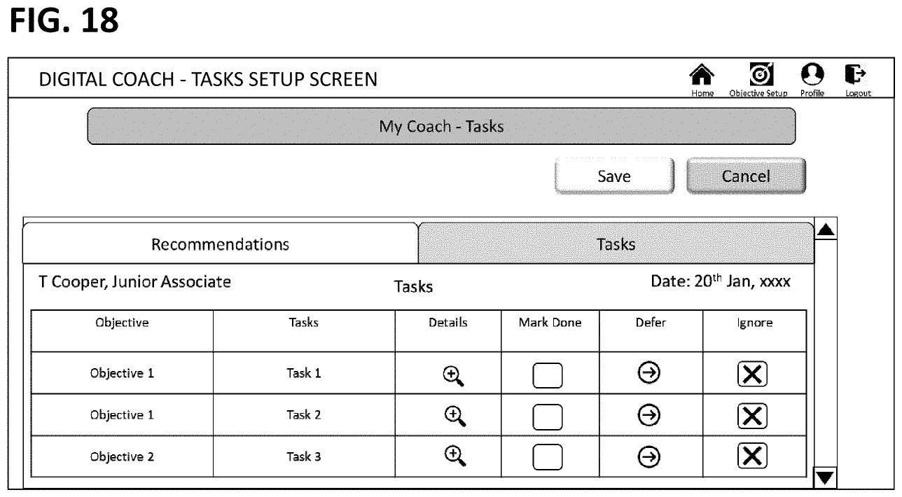

Sub-Process 700B (Deploy Ideas)—This sub-process allows ideas collated from the larger organization to be presented to an employee and allowing the employee to adopt these with the intent of improving their objectives achievement.
Block 704: For every employee, on a monthly/quarterly basis, ideas collected and curated in the previous step are presented to the employee through the user interface shown in FIG. 17.
Block 705: Employee chooses to accept, defer, or ignore these ideas in the user interface as shown in FIG. 17—widget 1701.
Block 706: On acceptance, the ideas are converted to tasks where the employee can mention the reminder and alerting frequency so that this can become a habit, as shown in FIG. 18.

Sub-Process 700C (Collect Feedback)—The sub-process lets the employees rate the ideas they selected earlier on in the year on a 5 point scale to allow further feedback so that the ideas can be made more relevant for the employees.
Block 707: On completion of an objective or the target date of the objective, if the employee had opted to practice some of the steps, they are presented with the user interface to rate the idea and give feedback on whether it worked for them or why not.
Block 708: Algorithms are used to calculate the average employee ratings and can now be displayed in the user interface for future employees getting these objectives.
Block 709: The additional information is presented on the user interface to the future employees in the next annual cycle to help them understand which ideas work more than others.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A method and a software product for business performance management and employee performance enhancement of an organization, comprising:
(a) an objective distribution module or flow down system for enabling flow down, or delegation, of an objective-setting procedure from top to bottom of the organization ensuring alignment of objectives across the organization;
(b) an objectives confidence assessment module or flow up system for collecting and analyzing employee objective achievement sentiment improving business performance from bottom to top of the organization and using the analysis for driving better management support for employees; and
(c) an objective achievement coaching module for helping employees to self-improve themselves.

2. A computer system for business performance management and employee performance enhancement of an organization, comprising:
(a) an objectives distribution (setup, delegation, and negotiation) module for delegating organizational objectives from top to the bottom of an organization;
(i) said objectives distribution module being operative to enable a delegating manager at the organization's highest leadership level to store information on new objectives for each annual year, and to digitally transfer the responsibility for executing delegation of these new objectives, fully or partially, to said delegating manager's immediate direct reports;
(ii) said objectives distribution module additionally enabling the delegating managers to store information on how frequently he/she wants to see the confidence levels of achieving these objectives and to allocate risks typically associated therewith;
(iii) said objectives distribution module being further operative to store communications between the delegation manager and his/her direct reports for adjustments to the objectives and acceptance thereof with a date and time stamp, thereby creating a delegate-negotiate-accept procedure; and
(iv) upon said acceptance, said objectives distribution module being operative to allow each of these direct reports to create and store sub-objectives to their accepted objectives and delegate these objectives to employees who report into them in accordance with said delegate-negotiate-accept procedure;
whereby said objectives distribution module allows each manager in the organization to delegate all or some of the accepted objectives to their direct reports until those objectives have been delegated to employees who do not have any direct reports.
(b) an objectives confidence level assessment module for identifying throughout a performance year the objective confidence levels of the organization's employees;
ii. said objectives confidence level assessment module being operative to allow the employees to enter their confidence levels at specified intervals on achieving their objectives and additionally enter/rate the risks that can potentially affect their confidence levels;
iii. the risks levels reported by each direct report being updated to the existing risks for the respective manager;
iv. a weighted average of the confidence levels being averaged to derive a personal objectives confidence score for each employee on a given date, which is tracked over the year to monitor the confidence of each employee concerning the achievement of objectives; and
v. said personal objectives confidence score of all direct reports being averaged for each employee-manager, and data from said direct reports being aggregated and presented to said employee-manager by said objectives confidence level assessment module to enable said employee manager to assess his team's confidence levels and create a common understanding with the direct reports;
b. an objectives achievement coaching module for improving personal performance levels which collates best practices on executing various objectives from the organization and allows individual employees to create tasks for these and setup repeated reminders with the goal of improving personal performance.

3. A computer system for business performance management and employee performance enhancement of an organization, as recited by claim 2, said system being operative to digitally delegate objectives to an organization, collect confidence levels of employees throughout the year, and aggregate scores at incremental layers of management to drive faster decision making for enhancing organizational performance.

4. The system of claim 3, wherein the highest level of an organization leader assigns new objectives for each annual year and delegates these to his immediate direct reports, and this process is repeated until the objectives have been delegated to each of the employees who does not have any direct reports.

5. The system of claim 4, wherein the manager also specifies how frequently he wants to see updates on each objective and may also specify risks that he deems are important to track on the objective, said direct reports being able to negotiate with their manager (or in rare cases decline one or more objectives) prior to accepting said objectives, said direct reports also being able to delegate these objectives further to their own direct reports using a delegate-negotiate-accept process and to specify their preferences on an updating frequency as well as risks to be tracked, each layer of the organization then delegating said objectives to the next layer of organization until the delegation has been carried out for employees who do not have any direct reports.

6. An Internet-based software system for Enterprise Business Performance Enhancement comprising:
(a) a central computer server system connected to the Internet and adapted to be accessed by one or more authorized personal computers having minimal hardware and software requirements that include a PC with Internet access through a web browser program and/or a mobile handheld device with access to Internet, a mobile browser and/or app;
(b) said central computer server system having an operating system, a database management system, high bandwidth connection to the Internet, and an email server system;
(c) said central computer server system having four functional software modules, which comprise:
i. an Enterprise Objectives Distribution module having visual interface and processing components for entering and storing the information on delegation of the organizational objectives from the top to the bottom of an organization;
(ii) an Employee Objectives Confidence Level Assessment module having visual interface and processing components for entering and storing the objective confidence levels of individual employees of the organization throughout a performance year, to derive metrics and document actions taken to enhance confidence levels or achievement of business objectives;
iii. an Objectives Achievement Coaching module having visual interface and processing components for generating, viewing and storing system/peer generated personalized suggestions for employee objectives performance improvement, storing the acceptance from each employee and generating alerts and reminders for the employee of these tasks and activities; and
iv. a Dashboard module showing summary information from each of the other modules.

7. In an Enterprise Objectives Delegation module as recited by claim 6, having visual interface and processing components for entering and storing the information on delegation of the organizational objectives from the top to the bottom of an organization, the improvement wherein:
a. said visual interface component enables a highest level organization leader to enter and store information on new organizational objectives for each annual year, targets for the objectives and weightage given thereto, how frequently said leader wants to see confidence levels for achieving these objectives and risks to be monitored for these objectives;
b. said visual interface component also enabling said leader to digitally delegate said organizational objectives fully or partially to immediate direct reports;
c. said visual interface component allowing the said leader and his direct reports to enter and store the two-way communications for negotiations and revisions to the objectives and, once agreed upon, store acceptances of these objectives with a date and time stamp by the direct reports in accordance with a Delegate-Negotiate-Accept procedure;
d. following acceptance of objectives by said direct reports, said module allowing each of said direct reports to create and store sub-objectives to their accepted objectives and delegate these objectives to employees who directly report into them in accordance with a Delegate-Negotiate-Accept procedure; and
e. said processing component containing an algorithm logic means for ensuring that weightage of said organizational objectives for each employee is always 100%, said processing component also ensuring that sub-objectives of any direct reports are linked to parent objectives of said leader.

8. In an Objectives Confidence Assessment Module as recited by claim 6, having visual interface and processing components for entering and storing objective confidence levels of individual employees of the organization throughout a performance year and for deriving metrics and document actions taken to enhance confidence levels/business objectives achievement, the improvement wherein:
a. said visual interface component of the module being operative to allow the employees to enter and store their confidence levels on achieving their objectives, said entry and storage of employee confidence levels being allowed by said module at any time but at a minimum at the interval specified at the time the employee accepts his objectives;
b. said visual interface component also being operative to allow the employees to enter and store their ratings on likeliness of associated risks affecting their ability to achieve accepted objectives, along with reason for said associated risks, what actions have been taken, and help needed to mitigate or reduce said risks;
c. said visual interface component being further operable to enable the employee's manager to view help needed by his direct report and allowing him to approve or reject with reason, or request approval from his own manager through said visual interface component;
d. said processing component having algorithm logic for calculating the weighted average of the confidence levels for all the objectives of each employee, said weighted average of an employee's confidence level for all objectives being referenced as a Personal Objectives Confidence Score or POCS;
e. said processing component being operative to refresh said POCS each time the employee updates his confidence levels, thereby creating a new POCS that is shown visually to the employee on a module screen as well as on a dashboard module;
f. said processing component further averaging for a manager, the Personal Objectives Confidence Score of each of the manager's direct reports to thereby calculate a Team Objectives Confidence Score or TOCS every time any of the manager's direct reports updates their POCS and presents this information on the visual interface of the Objectives Confidence Level Collation Module and the Dashboard module.

9. An Objectives Achievement Coaching module as recited by claim 6, having visual interface and processing components for generating, viewing and storing system or peer generated personalized suggestions for employee objectives performance improvement, storing an acceptance from each employee to adopt these suggestions and generating alerts and reminders for the employee of these tasks and activities, said Objectives Achievement Coaching module comprising:
a. a visual user interface component for displaying the ideas/suggestions generated by the processing component to an employee for improving performance and helping said employee to accept/defer/decline said ideas or suggestions;
b. said processing component being operative, when an idea or suggestion is accepted, to enable said employee to select a frequency for reminders to schedule tasks related to said ideas or suggestions
c. said processing component being further operative to enable employees to provide their best practices, suggestions and ideas for other employees, request help concerning some business development areas and volunteer to mentor other employees when requested;
d. said processing component having algorithm logic and being operable to (i) compare values stored in a user self-profile, (ii) compare the user's objectives for the year, (iii) compare the career aspirations of the employee, (iv) create and store suggestions in a database for the employee, and (v) display each of items (i) through (iv) said on the visual interface.

10. A computer-implemented method for Enterprise Business Performance Enhancement, comprising the steps of:
a. delegating objectives from top to bottom of an organization starting with the executive leaders of the organization using a computer system to create the objectives for organization;
b. delegating said created organizational objectives to said executive leaders' direct reports;
c. said executive leaders, after a negotiation process, accepting these objectives and then delegating said accepted objectives to their direct reports using said computer system;
d. said delegation process of steps “a” through “c” being repeated until the objectives have been delegated downward to substantially all employees of the organization through the computer system;
e. preparing Collation of Confidence levels with regard to each objective of each employee at weekly, bi-weekly or monthly intervals over a period of one year;
f. said employees augmenting said Collation of Confidence levels to identify the risks perceived and said managers using information derived from said augmented Collation of Confidence levels to facilitate achievement of their team members' business objectives, thereby achieving said managers' business objectives and enhancing the business performance of said organization; and
g. encouraging employees to share and get best practices from others or said system to improve their own business objectives performance and thereby improve their personal as well as organizational performance.
